(19) United States
(12) Patent Application Publication
(10) Pub. No.: US 2014/0105807 A1
(43) Pub. Date: Apr. 17, 2014

(54) Non-thermal plasma synthesis with carbon component

(71) Applicants: Rongsheng Ruan, Arden Hills, MN (US); Shaobo Deng, Eden Prairie, MN (US); Zhiping Le, Nanchang (CN); Yanling Cheng, Beijing (CN); Xiangyang Lin, Fuzhou (CN); Ling Chen, Rosevillle, MN (US)

(72) Inventors: Rongsheng Ruan, Arden Hills, MN (US); Shaobo Deng, Eden Prairie, MN (US); Zhiping Le, Nanchang (CN); Yanling Cheng, Beijing (CN); Xiangyang Lin, Fuzhou (CN); Ling Chen, Rosevillle, MN (US)

(21) Appl. No.: 14/140,993

(22) Filed: Dec. 26, 2013

Related U.S. Application Data
(63) Continuation of application No. 13/119,672, filed on May 27, 2011, now Pat. No. 8,641,872.

(30) Foreign Application Priority Data
Sep. 16, 2009 (US) US2009/057067

(51) Int. Cl. C01C 1/04

(52) U.S. Cl. CPC C01C 1/0494
USPC 423/355; 204/157.52; 204/157.47

(57) ABSTRACT

The disclosure herein describes a method for producing ammonia by introducing N₂, CO and water into a non-thermal plasma in the presence of a catalyst, the catalyst being effective to promote the disassociation of N₂, CO and water to form reactants that in turn react to produce NH₃ and CH₄.

This disclosure also describes producing a reactive hydrogen ion or free radical by the method comprising passing water through a non-thermal plasma in the presence of a catalyst, the catalyst being effective to promote the dissociation of water.

This Application is a Continuation Application of U.S. patent application Ser. No. 13/119,672, filed May 27, 2011, which is a Section 371 National Stage Application of International Application No. PCT/US2009/057067 filed Sep. 16, 2009 and published as WO 2010/033530 A2 on Mar. 25, 2010, the content of which are hereby incorporated by reference in their entirety.

This invention relates to non-thermal plasma reactors and to the use of non-thermal plasma to dissociate molecules in a gas phase using low energy levels to produce reactants that form reacting products.

Adverse environmental impact, rising non-renewable chemical feedstock costs, safety, and costs associated with waste management and equipment are serious concerns of the chemical and energy industries. Many chemical synthesis involve chemical reactions under severe conditions which generate polluting and hazardous wastes. Aimed at reducing or eliminating the use and generation of hazardous substances in chemical synthesis, the concept of “sustainable chemistry” or “green chemistry” gained acceptance about two decades ago.

One important chemical process is the production of fertilizer. For most agricultural crops, fertilizers are necessary to optimize yield. The invention of synthetic nitrogen fertilizer is arguably one of the great innovations of the agricultural revolution in the 19th-century. Nitrogen fertilizer is a necessary macronutrient and is applied infrequently and normally prior to or concurrently with seeding. Nitrogen based fertilizers include ammonia, ammonium nitrate and anhydrous urea, all being products based on the production of ammonia.

Ammonia is generated from a process commonly known as the Haber-Bosch Process. The Haber-Bosch Process includes the reaction of nitrogen and hydrogen to produce ammonia. The Haber-Bosch Process has been used since the early 1900s to produce ammonia which in turn has been used to produce anhydrous ammonia, ammonium nitrate and urea for use as fertilizer. The Haber-Bosch Process utilizes nitrogen obtained from air by fractional distillation and hydrogen obtained from methane (natural gas) or naphtha. There is an estimate that the Haber-Bosch Process produces 100 million tons of nitrogen fertilizer per year and consumes approximately 1% of the world's annual energy supply. Nitrogen fertilizer, however, is responsible for sustaining approximately 40% of the earth's population.

There are also other processes that require significant amounts of energy performed in traditional or conventional conditions. For example, Synthetic gas (Syngas) made primarily of carbon monoxide and H₂ may be used to form various synthetic hydrocarbon products. Syngas is made through gasification of a solid carbon based source such as coal or biomass. One example of use of Syngas as a feedstock is the Fischer-Tropsch process which is a catalyzed reaction wherein carbon monoxide and hydrogen are converted into various liquid hydrocarbons. Typical catalysts used are based on iron, cobalt and ruthenium. Resulting products are synthetic waxes, synthetic fuels and olefins.

### SUMMARY OF THE INVENTION

The disclosure herein describes a method for producing ammonia by introducing N₂, CO and water into a non-thermal plasma in the presence of a catalyst, the catalyst being effective to promote the disassociation of N₂, CO and water to form reactants that in turn react to produce NH₃ and CH₄.

This disclosure also describes producing a reactive hydrogen ion or free radical by the method comprising passing water through a non-thermal plasma in the presence of a catalyst, the catalyst being effective to promote the dissociation of water.

### BRIEF DESCRIPTION OF THE DRAWINGS

FIG. 1 is a graphical view of an FT-IR spectroscopy of reaction production of CO and H₂O.

FIG. 2 is a graphical view of FT-IR spectroscopy of reaction production of N₂, CO and H₂O.

FIG. 3 is a schematic view of one embodiment of the apparatus used to produce ammonia and methane.

FIG. 4 is a graphical view of an FT-IR spectroscopy of reaction of N₂ and H₂O on Ru—Pt—Cs/MgO catalyst.

FIG. 5 is a schematic view of one reaction scheme of this invention.

### DETAILED DESCRIPTION

One aspect of the present disclosure relates to a method in which a Non-thermal plasma (NTP) in a silent discharge (dielectric barrier discharge) reactor is used to assist a catalyzed reaction to increase ammonia production. In an application filed by the inventor herein on Aug. 21, 2008 under the Patent Cooperation Treaty having Serial Number US08/09948 titled Non-Thermal Plasma Synthesis of Ammonia (Publication No. WO 2009-025835A1), ammonia production utilizing a non-thermal plasma reactor in which a catalyst system comprising Ru—Pt—Cs/MgO was used to produce ammonia was described and which is hereby incorporated in its entirety. However, as was discovered, the ammonia content was limited due to the formation of N₂O and NO. If oxygen was eliminated, it is believed that the reaction would move towards the direction favoring more ammonia production.

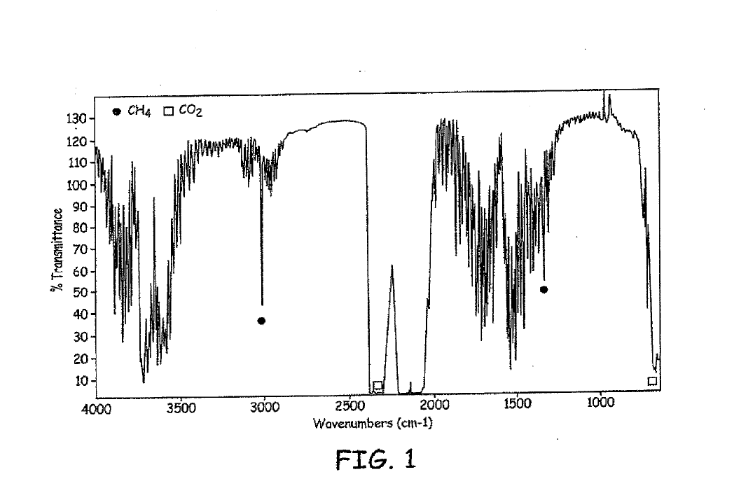

We have found that the introduction of CO into the above reaction system reduces the amount of O₂. The addition of CO increased the ammonia yield due to CO₂ formation. The formation of CO₂ eliminates O free radicals thereby reducing the formation of N₂O and NO. CO and H₂ can form hydrocarbons in a Fisher-Tropsch synthesis. Like N—N bond in N₂, the C—O bond in CO₂ can be broken. The resulting C free radical can form a hydrocarbon with the H free radical from water vapor. This is evidenced by the results shown in FT/IR spectroscopy of FIG. 1. The formation of CO₂ suggests that O was removed by the reactions. It is believed that the reactions are as follows:

CO→C+O

H₂O→H+OH

C+H→CH

C+OH→CH+O

CH+H→CH₂

CH₂+H→CH₃

CH₃+H→CH₄

2OH→H₂O₂

H₂O₂→H₂O+O

CO+O→CO₂

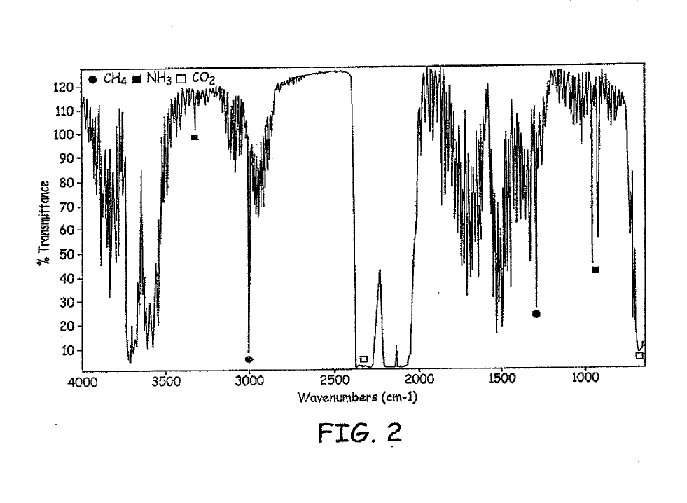

When N₂ was added to the system, it was found that ammonia, methane along with other hydrocarbons and other chemicals were formed in the product stream as indicated in the FT-IR spectroscopy of FIG. 2. The possible chemical pathways when N₂ was added are as follows:

H₂O→H+OH

N₂→N+N

N+H→NH

N+OH→NH+O

NH+H→NH₂

NH₂+H→NH₃

2OH→H₂O₂

H₂O₂→H₂O+O

N+O→NO

N+NO→N₂O

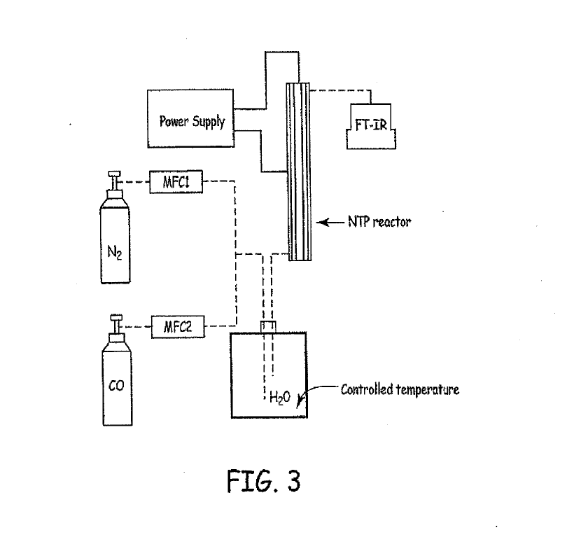

FIG. 3 illustrates the experimental setup that was used to produce the results herein described.

In the experimental setup of FIG. 3, N₂ and CO are provided in gaseous form. The rate of N₂ and CO are controlled by master flow controllers, MfC₁ and MfC₂, respectively. N₂ and CO are mixed and transported into a tank containing water. The temperature of the water is controlled by an automatic temperature controller. The temperature of the water may be between 0 and 100° C. The closer the temperature is to 100° C., the more water vapor is generated. The temperature of the water is maintained at a temperature sufficient to provide water vapor in stochiometric excess to the NTP reactor. The N₂ and CO gas mixture is passed through the water, and mixes with the water vapor, carrying the water vapor into the NTP reactor.

In addition to the Ru—Pt—Cs/MgO catalyst system, it is believed that K/Ru, Cs/Ru, Ca/ru, Fe/Ru, Co/Ru, Ni/Ru, and La/Ru may be substituted for the catalyst combination of Cs/Ru. It is believed that these combinations of catalysts work similar to the Cs/Ru catalyst combination in that a promoter catalyst is ionized at a low energy level and produces electrons which are passed onto catalyst Ru.

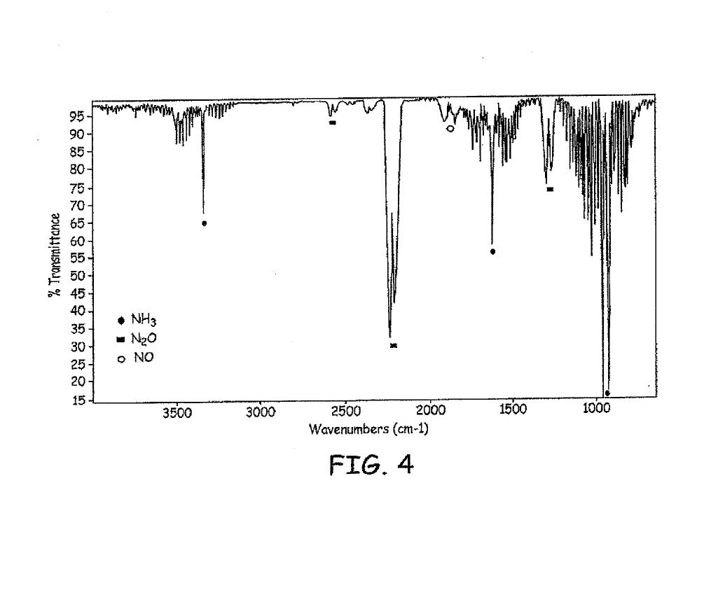

FIG. 4 shows gas samples by FT-IR at the outlet of the NTP. FIG. 4 shows that the gas contained NH₃, N₂O, and NO when the feed contained N₂ and water vapor. The NTP reactor with the catalyst of Ru—Pt—Cs/MgO provided the energy to break the O—H and N—N bonds, resulting in N, H, OH and O free radicals. The N and H free radicals then combined to form NH₃, it is believed according to the following reactions:

H₂O→H+OH

N₂→N+N

N+H→NH

N+OH→NH+O

NH+H→NH₂

NH₂+H→NH₃

2OH→H₂O₂

H₂O₂→H₂O+O

N+O→NO

N+NO→N₂O

Formation of ammonia and methane was found to vary with reaction conditions such as temperature, ratio of N₂ to CO and the feed gas, NTP related processing parameters and residence time. It is believed that the amount of ammonia and methane formed increases with increasing temperature likely due to the increased water vapor and thus higher concentration of H free radicals at higher temperatures as illustrated in Table 1.

TABLE 1
Effect of gas to water ratio on reaction

| Temperature (° C.) | 26 | 30 | 38 |
|---|---|---|---|
| NH₃/ppm | 9600 | 10000 | 14000 |
| CH₄/ppm | 5900 | 8300 | 21000 |

NTP reactor was operated at 6 KV, 8 KHz. Catalyst used was Ru—Cs/MgO. Gas flow rates: N₂: 50 ml/min, CO: 0.2 ml/min.

The effect of N₂ levels to CO (in ratio form) on the reaction is shown in Table 2.

TABLE 2
Effect of ratio of N₂ and CO on reaction

| CO:N₂ | 50:0.2 | 45:5 | 40:10 | 0.2:50 |
|---|---|---|---|---|
| NH₃/ppm | 5000 | 5600 | 6400 | 9600 |
| CH₄/ppm | 33000 | 25000 | 22000 | 5900 |

6 KV, 8 KHz, T = 26° C., Ru—Cs/MgO

Ammonia formation increases with increasing N₂ levels while methane formation increases with increasing CO levels.

Table 3, setforth below, shows that the amount of ammonia and methane formed increases with increasing plasma voltage. This can be attributed to the enhanced dissociation of molecular bonds at a higher electric field discharge.

TABLE 3
Effect of plasma voltage on reaction

| KV | 5 | 6 | 7 |
|---|---|---|---|
| NH₃/ppm | 8300 | 9100 | 12300 |
| CH₄/ppm | 13000 | 15000 | 24000 |

T = 26° C., 8 KHz, Ru—Cs—K/MgO, CO: 45 ml/min, N₂: 5 ml/min

An increased frequency of high voltage power promotes ammonia formation also, but has little influence on methane formation as shown in Table 4.

TABLE 4
Effect of plasma frequency on reaction

| KHz | 7 | 8 | 9 |
|---|---|---|---|
| NH₃/ppm | 2000 | 12300 | 7500 |
| CH₄/ppm | 25500 | 24000 | 24000 |

T = 26° C., 6 KV, Ru—Cs—K/MgO, CO: 45 ml/min, N₂: 5 ml/min

The concentration of ammonia or methane increased with reaction time. It is noticed that the formation of methane from reaction of CO and H₂O is faster than that of ammonia from reaction of N₂ and H₂O. This may be due to the difference in the polarity between N₂ and CO. N—N is a non-polar bond while C—O is a polar bond. The result suggests that the polar bond is easier to become dissociated than non-polar bond under the NTP environment.

TABLE 5
Effect of residence time on reaction

| | Time/min | | | | | | |
|---|---|---|---|---|---|---|---|
| | 5 | 10 | 15 | 20 | 30 | 40 | 50 |
| NH₃/ | 3500 | 4400 | 4800 | 5500 | 6500 | 7100 | 7500 |
| ppm | | | | | | | |
| CH₄/ | 23000 | 24000 | 24000 | 24000 | 24000 | 24000 | 24000 |
| ppm | | | | | | | |

T = 26° C., 6 KV, 8 KHz, Ru—Cs—K/MgO, CO: 45 ml/min, N₂: 5 ml/min

This invention shows that subcatalytic reactions which traditionally need high pressure and high temperature conditions to proceed can proceed under low pressures in ambient pressure with the assistance of a non-thermal plasma. The NTP effectively provides energy to overcome certain reaction barriers. It is believed that a non-thermal plasma works in synergy with certain catalysts directly dissociating gaseous molecules reactant to form highly reactive free radicals or ions while also possibly reducing the activation energy required by the catalysts to function efficiently.

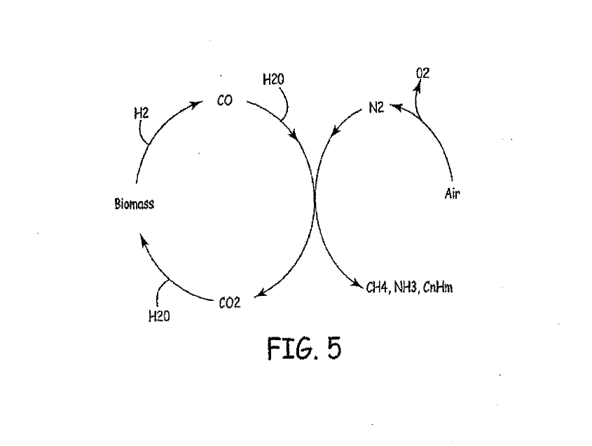

In the particular example described herein and as illustrated in FIG. 5, NTP assisted catalysis makes it possible to use water as a clean feed stock or a hydrogen source in chemical synthesis. The formation of methane and possibly other hydrocarbons in the CO—H₂O reaction system described herein in a NTP environment suggests a possible pathway for making hydrocarbon fuels from water and CO. CO is readily available from combustion of biomass in an incomplete combustion environment. Moreover, a NTP assisted catalysis has a broader impact on chemical synthesis through “green chemistry” by utilizing renewable feed stocks such as water and biomass while producing no hazardous waste under mild conditions.

Although the present invention has been described with reference to preferred embodiments, workers skilled in the art will recognize that changes may be made in form and detail without departing from the spirit and scope of the invention.

1. A method for producing ammonia, the method comprising:
introducing N₂, CO and H₂O into a non-thermal plasma in the presence of a catalyst and a promoter wherein the promoter ionizes and produces electrons that are passed onto the catalyst, the catalyst and the promoter being effective to promote the dissociation of N₂, CO and H₂O to reactants that in turn then react to produce NH₃ and CH₄.

2. The method of claim 1 wherein the H₂O is passed into the reactor by passing CO and N₂ gas through liquid water with the N₂ and CO carrying the water into the non-thermal plasma.

3. The method of claim 1 wherein the catalyst is an electron donor.

4. The method of claim 1 wherein the catalyst is Ruthenium.

5. The method of claim 1 wherein the catalyst is Ruthenium and the promoter is an electron donor having an ionization energy less than Ruthenium.

6. The method of claim 1 wherein the catalyst is provided in a packed bed through which the N₂, CO and H₂O flow.

7. The method of claim 1 wherein an additional reaction product is CₙHₘ where n is greater than 1 and m is greater than 4.

8. The method of claim 1 wherein the CO is obtained from biomass through an incomplete combustion.

9. A method of producing a reactive hydrogen ion, hydrogen radical, and/or carbon free radical, the method comprising passing water through a non-thermal plasma in the presence of a catalyst and a promoter, wherein the promoter ionizes and produces electrons that are passed onto the catalyst, the catalyst and promoter being effective to promote the dissociation of water and production of reactive carbon free radicals.

10. The method of claim 9 wherein the catalyst is an electron donor.

11. The method of claim 9 wherein the catalyst is Ruthenium.

12. The method of claim 9 wherein the catalyst is Ruthenium and the promoter is an electron donor having an ionization energy less than Ruthenium.

13. The method of claim 9 wherein the catalyst is provided in a packed bed through which the water is passed.

14. The method of claim 13 wherein the water is passed through the packed bed using a carrier gas.

15. The method of claim 1 wherein the promoter is Cesium.

16. The method of claim 1 wherein the ionization energy of the promoter is less than the energy provided by the non-thermal plasma.

17. The method of claim 9 wherein the promoter is Cesium.

18. The method of claim 9 wherein the ionization energy of the promoter is less than the energy provided by the non-thermal plasma.
